(19) United States
(12) Patent Application Publication
(10) Pub. No.: US 2026/0229884 A1
(43) Pub. Date: Aug. 6, 2026

(54) VOLTAGE-LIMITING CIRCUIT AND FIELD DEVICE COMPRISING SUCH A VOLTAGE-LIMITING CIRCUIT

(71) Applicant: Endress+Hauser Wetzer GmbH+Co. KG, Nesselwang (DE)

(72) Inventors: Thomas Georg Härle, Oy-Mittelberg (DE); Wilhelm Schneider, Füssen (DE)

(21) Appl. No.: 19/138,176

(22) PCT Filed: Dec. 13, 2023
(86) PCT No.: PCT/EP2023/085591

§ 371 Date: Jun. 12, 2025

(30) Foreign Application Priority Data
Dec. 16, 2022 (DE) 20 2022 107 046.6

(51) Int. Cl. H02H 9/04

(52) U.S. Cl. CPC H02H 9/047

(57) ABSTRACT

A voltage-limiting circuit) for the ignition protection type “ia,” comprises precisely two monolithic voltage-limiting modules, wherein each voltage-limiting modules has: a supply voltage connection; a circuit ground connection; a voltage divider arranged between the supply voltage connection and the circuit ground; a controller with a control signal output; an actuator with an actuator signal input and a current channel, the resistance value of which is based on the control signal applied to the actuator signal input, wherein the current channel runs parallel to the voltage divider between the supply voltage connection and the circuit ground, wherein an input of the controller is supplied with the divider voltage of the voltage divider, wherein the control signal output is connected to the actuator signal input, wherein the supply voltage connection and the circuit ground connection of the two voltage-limiting modules are to be arranged parallel to a supply voltage source.

The present invention relates to a voltage-limiting circuit and a field device of process automation technology comprising such a voltage-limiting circuit.

Field devices serving to record and/or modify process variables are frequently used in process automation technology. Sensors, such as fill-level measuring devices, flow meters, pressure and temperature measuring devices, pH redox potential meters, conductivity meters etc., are used for recording the respective process variables, such as fill level, flow, pressure, temperature, pH level, and conductivity. Actuators, such as, for example, valves or pumps, are used to influence process variables. The flow rate of a fluid in a pipeline section or a fill-level in a container can thus be altered by means of actuators. In principle, all devices that are used in-process and that supply or process process-relevant information are referred to as field devices. In the context of the invention, field devices also include remote I/Os, radio adapters, and/or, in general, devices that are arranged at the field level. Many field devices are available in so-called 2-wire devices. The field device is supplied via the same pair of lines (two-wire line) that is used for communication, in particular for measured values. In process automation technology, physical or technical quantities often have to be measured or determined by field devices in potentially explosive areas where there is a risk of explosion due to the process media. By means of suitable measures in the field devices and evaluation systems (e.g., voltage and current limitation), the electrical power of the signals to be transmitted can be limited so that they cannot trigger an explosion under any circumstances (short circuit, interruptions, thermal effects, etc.). For this purpose, for example, corresponding protection principles have been defined in IEC EN DIN 60079-ff. According to this standard, design and circuitry measures for the field devices for use in potentially explosive areas are defined on the basis of the ignition protection types to be applied. One of these ignition protection types represents the ignition protection type “intrinsic safety” (identification code Ex-i, IEC EN DIN 60079-11, published June 2012). The ignition protection type “intrinsic safety” is based on the principle of limiting current and voltage in a circuit. The power in the circuit which could be capable of igniting an explosive atmosphere is limited such that the surrounding explosive atmosphere cannot be ignited either by sparks or by impermissible heating of the electrical components.

The ignition protection type “intrinsic safety” defines three protection levels: Ex-ia, Ex-ib and Ex-ic. In this case, the highest level is defined by level a, at which two countable faults in their combination do not lead to a malfunction and thus cause ignition (2-fault safety). Level b defines that one countable fault does not lead to a malfunction and thus cause an ignition (1-fault safety). In the case of level c, no error safety is defined, so that, in the case of one malfunction, an ignition can already be triggered (0-fault safety). Circuit-related measures for achieving intrinsic safety usually comprise current limitation, voltage limitation and, associated with this, power limitation, wherein this is usually achieved by limiting circuits in a triple-redundant configuration. Such voltage-limiting circuits are disclosed, for example, in DE 10 2006 056 591A 1 .

The disadvantage of the triple-redundant limiting circuits is, on the one hand, their increased space requirement and, on the other hand, the relatively high power consumption. The object of the present invention is to remedy this.

This object is achieved, according to the invention, by the voltage-limiting circuit according to claim 1 and the field device according to claim 10.

The voltage-limiting circuit according to the invention is a voltage-limiting circuit for the ignition protection type “ia,” comprising precisely two monolithic voltage-limiting modules, wherein each voltage-limiting modules has: a supply voltage connection; a circuit ground connection; a voltage divider for providing a divider voltage, wherein the voltage divider is arranged between the supply voltage connection and the circuit ground; a controller with a control signal output for outputting a control signal; an actuator with an actuator signal input and a current channel, the resistance value of which is based on the control signal applied to the actuator signal input, wherein the current channel runs parallel to the voltage divider between the supply voltage connection and the circuit ground, wherein an input of the controller is supplied with the divider voltage of the voltage divider, wherein the control signal output is connected to the actuator signal input, wherein, in particular, the supply voltage connection and the circuit ground connection of the two voltage-limiting modules are to be arranged parallel to a supply voltage source.

In a further development of the invention, the actuator comprises a transistor, wherein the actuator signal input comprises a base connection of a bipolar transistor or a gate connection of a field effect transistor.

In a further development of the invention, the voltage-limiting modules each further have a freewheeling diode, which is connected parallel to the current channel of the actuator.

In a further development of the invention, the controller comprises an operational amplifier and a reference voltage source, in particular a bandgap voltage reference, wherein a first input of the operational amplifier is supplied with the divider voltage of the voltage divider, wherein a second input of the operational amplifier is connected to the reference voltage source, and wherein an output of the operational amplifier is the control signal output.

In a further development of the invention, the voltage-limiting modules each further have a resistance element, which is arranged between the control signal output and the supply voltage connection.

In a further development of the invention, the voltage-limiting modules each have a base area of not more than 18 mm², in particular not more than 12 mm².

In a further development of the invention, the actuators have the largest area share of all the functional elements of the voltage-limiting modules mentioned.

In a further development of the invention, transistors of the voltage-limiting modules each have a barrier layer, wherein the barrier layers have a temperature of not more than 150° C. at an ambient temperature of the voltage-limiting circuit of up to 85° C. and a power consumption of the voltage-limiting modules of up to 1.4 W each.

In a further development of the invention, the transistors of the voltage-limiting modules each have a barrier layer, wherein the barrier layer has a power-dependent temperature increase of not more than 60° C./W, in particular not more than 45° C./W, at an ambient temperature of the voltage-limiting circuit of up to 85° C. and a power consumption of the voltage-limiting modules of up to 1.4 W each.

The field device for process automation technology according to the invention comprises: a sensor; a measuring and operating circuit for operating the sensor and for processing signals from the sensor; and a supply circuit that has a supply voltage source for supplying the measuring and operating circuit and a voltage-limiting circuit according to any of the preceding claims, wherein the voltage-limiting modules are connected parallel to the supply voltage source.

The invention is now explained in more detail on the basis of the exemplary embodiments shown in the figures. In the drawings:

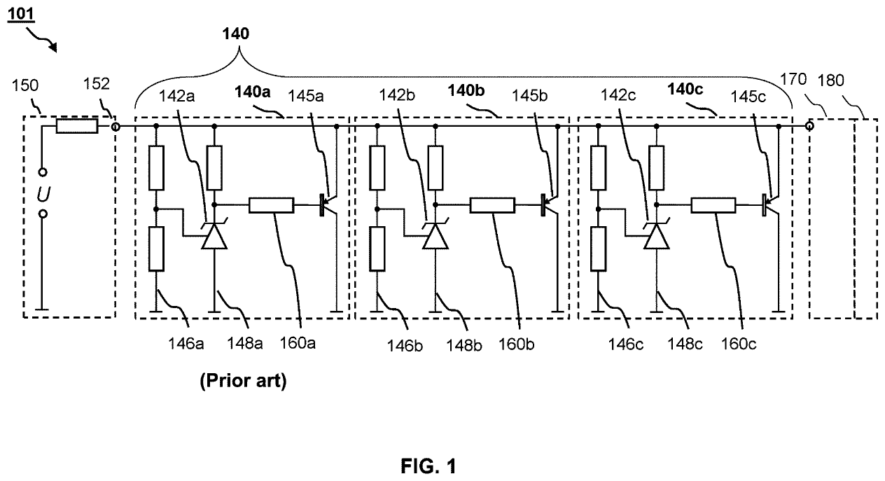

FIG. 1 is a schematic representation of a field device with a voltage control circuit according to the prior art;

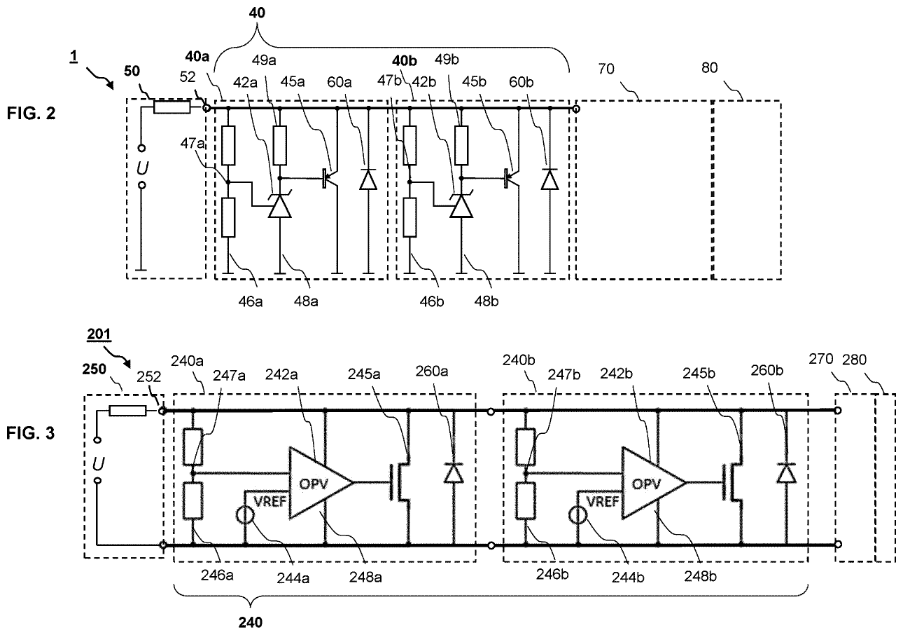

FIG. 2 is a schematic representation of an exemplary embodiment of a field device according to the invention with a first exemplary embodiment of a voltage control circuit according to the invention; and

FIG. 3 is a schematic representation of an exemplary embodiment of a field device according to the invention with a second exemplary embodiment of a voltage control circuit according to the invention.

The field device shown in FIG. 1 according to the prior art comprises a supply circuit 150, a voltage-limiting circuit 140, a measuring and operating circuit 170, and a sensor 180, which is operated by the measuring and operating circuit 170, wherein the latter receives and processes measurement signals from the sensor 180. The voltage-limiting circuit 140 comprises three discretely structured voltage-limiting modules 140a, 140b, 140c, which are connected parallel to the measuring and operating circuit to a supply voltage connection 152 of the supply circuit 150. The discrete structure of the voltage-limiting modules requires a triple-redundant configuration in order to comply with explosion protection class “ia.” The voltage-limiting modules 140a, 140b, 140c each comprise a transistor 145a, 145b, 145c as an actuator, the current channel of which runs between the supply voltage connection 152 and the circuit ground. Supply voltage whose base is connected via a resistance element 160a, 160b, 160c to the output of a controller 148a, 148b, 148c, which here has a controllable voltage source 142a, 142b, 142c. A control signal for the voltage source is provided from the output or center tap of a voltage divider 146a, 146b, 146c. The voltage-limiting circuit 140 fulfills its purpose, but is disadvantageous in that the discretely structured voltage-limiting modules 140a, 140b, 140c, each with an area of 36 mm², contribute to a large total space requirement of 108 mm². In addition, the resistance elements 160a, 160b, 160c contribute to limiting the base current of the transistors 145a, 145b, 145c to the power consumption of the voltage-limiting circuit 140.

The present invention is based on Section 7.5.2 Voltage Limiter Circuits in Parallel of the IEC EN DIN 60079-11 standard, published June 2012, according to which a double-redundant configuration of the voltage-limiting circuit is acceptable if in each case it has two monolithically designed voltage-limiting modules that are fully implemented using semiconductor technology. This allows both the space requirement and the power consumption of the voltage-limiting circuit to be minimized.

The exemplary embodiment of a field device 1 according to the invention with a voltage-limiting circuit 40 according to the invention shown in FIG. 2 comprises a supply circuit 50, a voltage-limiting circuit 40, a measuring and operating circuit 70, and a sensor 80, which is operated by the measuring and operating circuit 70, wherein the latter receives and processes measurement signals from the sensor 80. The voltage-limiting circuit 40 comprises only two monolithic voltage-limiting modules using semiconductor technology 40a, 40b, which are connected parallel to the measuring and operating circuit to a supply voltage connection 52 of the supply circuit 50. The monolithic implementation of the voltage-limiting modules makes possible a double-redundant configuration in order to comply with explosion protection class “ja.” The voltage-limiting modules 40a, 40b each comprise a transistor 45a, 45b as an actuator, the current channel of which runs parallel between the supply voltage connection 52 and the circuit ground, and the base of which is connected to the output of a controller 48a, 48b, which here has an adjustable parallel voltage controller 42a, 42b. A control signal for the parallel voltage controller is provided from the output or center tap 47a, 47b of a voltage divider 46a, 46b, which is also connected parallel between the supply voltage and the circuit ground. In the event of the voltage rising above a target value, the current flow through the transistor 45a, 45b is increased by controlling the base of the transistor until the voltage is reduced again to the target value.

Here, the voltage-limiting modules 40a, 40b are designed so that at a power consumption of 1.4 W, which corresponds to 1.5 times the maximum possible power to be handled, and at an ambient temperature of 85° C., the barrier layer of the transistor does not exceed a temperature of 150° C. Furthermore, the voltage-limiting modules 40a, 40b are designed so that the current channel can carry a current of 150 mA, which corresponds to 1.5 times the maximum possible current. This is achieved in particular by the fact that the transistors 45a, 45b each have a relatively large area share of the total area of a voltage-limiting module 40a, 40b. The voltage-limiting modules 40a, 40b can each be implemented with a base area of 9 mm². Since only two such voltage-limiting modules are required, the entire voltage-limiting circuit 40 has a base area of only 18 mm², which corresponds to approximately one sixth of the base area of a discretely structured voltage-limiting circuit according to the prior art. The voltage-limiting modules also each comprise a freewheeling diode 60a, 60b to be able to reduce voltage surges of the opposite polarity to the supply voltage, for example due to inductances.

The exemplary embodiment of a field device 201 according to the invention with a voltage-limiting circuit 240 according to the invention shown in FIG. 3 comprises a supply circuit 250, a voltage-limiting circuit 240, a measuring and operating circuit 270, and a sensor 280, which is operated by the measuring and operating circuit 270, wherein the latter receives and processes measurement signals from the sensor 280. The voltage-limiting circuit 240 comprises only two monolithic voltage-limiting modules using semiconductor technology 240a, 240b, which are connected parallel to the measuring and operating circuit to a supply voltage connection 252 of the supply circuit 250. The monolithic implementation of the voltage-limiting modules makes possible a double-redundant configuration in order to comply with explosion protection class “ia.” The voltage-limiting modules 240a, 40b each comprise a field effect transistor 245a, 245b as an actuator, the current channel of which runs parallel between the supply voltage connection 252 and the circuit ground, and the gate of which is connected to the output of a controller 248a, 248b, which here has an operational amplifier 242a, 42b. An input signal for a first input of the operational amplifier is provided from the output or center tap 247a, 247b of a voltage divider 246a, 246b, which is also connected parallel between the supply voltage and the circuit ground. At the second input of the operational amplifier 248a, 248b, there is a voltage reference signal 244a, 244b, which is provided in particular by a bandgap voltage reference. In the event of the voltage rising above a target value, the current flow through the field effect 245a, 245b is increased by controlling the gate of the transistor until the voltage is reduced again to the target value.

Here, the voltage-limiting modules 240a, 240b are designed such that at a power consumption of 1.4 W, which corresponds to 1.5 times the maximum possible power to be handled, and at an ambient temperature of 85° C., the barrier layer of the transistor does not exceed a temperature of 150° C. Furthermore, the voltage-limiting modules 240a, 240b are designed so that the current channel can carry a current of 150 mA, which corresponds to 1.5 times the maximum possible current. This is achieved in particular by the fact that the transistors 245a, 245b each have a relatively large area share of the total area of a voltage-limiting module 240a, 240b.

The voltage-limiting modules 240a, 240b can each be implemented with a base area of 9 mm². Since only two such voltage-limiting modules are required, the entire voltage-limiting circuit 240 has a base area of only 18 mm², which corresponds to approximately one sixth of the base area of a voltage-limiting circuit according to the prior art. The voltage-limiting modules also each comprise a freewheeling diode 260a, 260b to be able to reduce voltage surges of the opposite polarity to the supply voltage, for example due to inductances.

1-10. (canceled)

11. A voltage-limiting circuit for an ignition protection type “ia,” comprising:
precisely two monolithic voltage-limiting modules, each voltage-limiting module including:
a supply voltage connection;
a circuit ground connection;
a voltage divider for providing a divider voltage, wherein the voltage divider is arranged between the supply voltage connection and the circuit ground connection;
a controller with a control signal output for outputting a control signal; and
an actuator with an actuator signal input and a current channel, wherein the resistance value of the current channel is based on a signal applied to the actuator signal input,
wherein the current channel runs parallel to the voltage divider between the supply voltage connection and the circuit ground connection,
wherein an input of the controller is supplied with the divider voltage of the voltage divider,
wherein the control signal output is connected to the actuator signal input, and
wherein the supply voltage connection and the circuit ground connection of the two voltage-limiting modules are to be arranged parallel to a supply voltage source.

12. The voltage-limiting circuit according to claim 11,
wherein the actuator comprises a transistor,
wherein the actuator signal input comprises a base connection of a bipolar transistor or a gate connection of a field effect transistor.

13. The voltage-limiting circuit according to claim 11, wherein the voltage-limiting modules each further have a freewheeling diode that is connected parallel to the current channel of the actuator.

14. The voltage-limiting circuit according to claim 11, wherein the controller comprises an operational amplifier and a reference voltage source,
wherein a first input of the operational amplifier is supplied with the divider voltage of the voltage divider,
wherein a second input of the operational amplifier is connected to the reference voltage source, and
wherein an output of the operational amplifier is the control signal output.

15. The voltage-limiting circuit according to claim 11, wherein the voltage-limiting modules each further has a resistance element that is arranged between the control signal output and the supply voltage connection.

16. The voltage-limiting circuit according to claim 11, wherein the voltage-limiting modules each has a base area of not more than 18 mm².

17. The voltage-limiting circuit according to claim 16, wherein the actuators have a largest area share of all functional elements of the voltage-limiting modules.

18. The voltage-limiting circuit according to claim 12, wherein the transistors of the voltage-limiting modules each has a barrier layer, wherein the barrier layers have a temperature of not more than 150° C. at an ambient temperature of the voltage-limiting circuit of up to 85° C. and a power consumption of the voltage-limiting modules of up to 1.4 W.

19. The voltage-limiting circuit according to claim 12, wherein the transistors of the voltage-limiting modules each has a barrier layer, wherein the barrier layer has a power-dependent temperature increase of not more than 60° C./W at an ambient temperature of the voltage-limiting circuit of up to 85° C. and a power consumption of the voltage-limiting modules of up to 1.4 W.

20. A field device for process automation technology, comprising:
a sensor;
a measuring and operating circuit for operating the sensor and for processing signals from the sensor; and
a supply circuit including:
a supply voltage source for supplying the measuring and operating circuit; and
a voltage-limiting circuit for an ignition protection type “ia,” including:
precisely two monolithic voltage-limiting modules, each voltage-limiting module including:
a supply voltage connection;
a circuit ground connection;
a voltage divider for providing a divider voltage, wherein the voltage divider is arranged between the supply voltage connection and the circuit ground connection;
a controller with a control signal output for outputting a control signal; and
an actuator with an actuator signal input and a current channel, the resistance value of the current channel is based on a signal applied to the actuator signal input,
wherein the current channel runs parallel to the voltage divider between the supply voltage connection and the circuit ground connection,
wherein an input of the controller is supplied with the divider voltage of the voltage divider,
wherein the control signal output is connected to the actuator signal input, and
wherein the supply voltage connection and the circuit ground connection of the two voltage-limiting modules are connected parallel to the supply voltage source.
